(19) United States
(12) Patent Application Publication
(10) Pub. No.: US 2022/0283290 A1
(43) Pub. Date: Sep. 8, 2022

(54) OUTDOOR INTRUSION DETECTION SYSTEM

(71) Applicant: Dnet Co., Ltd., Daegu (KR)

(72) Inventor: Min Hyuk PARK, Daegu (KR)

(73) Assignee: Dnet Co., Ltd.

(21) Appl. No.: 17/346,703

(22) Filed: Jun. 14, 2021

(30) Foreign Application Priority Data
Mar. 5, 2021 (KR) 10-2021-0029358

(51) Int. Cl. G01S 13/86; H01Q 19/10; G01S 13/04

(52) U.S. Cl. CPC G01S 13/865; H01Q 19/10; G01S 13/04; G08B 29/185

(57) ABSTRACT

The present invention relates to an outdoor intrusion detection system including a transmitter transmitting microwaves and diffused infrared light, a receiver receiving microwaves and diffused infrared light transmitted from the transmitter so as to detect whether there is an intrusion or not, and avoid a false alarm triggered due to weather conditions and a small object.

### CROSS-REFERENCE TO RELATED APPLICATION OF THE INVENTION

The present application claims the benefit of Korean Application No. 10-2021-0029358, filed on Mar. 5, 2021, in the Korean Intellectual Property Office, the invention of which is incorporated by reference herein in its entirety.

### BACKGROUND OF THE INVENTION

### Field of the Invention

The present invention relates to an outdoor intrusion detection system for detecting an external intruder using both infrared and microwave detection methods. More particularly, the present invention relates to an outdoor intrusion detection system capable of expanding the beam divergence angle of infrared light to avoid a false alarm triggered and to expand the sensing region by separately installing a receiver and a transmitter.

### Background of the Related Art

In general, an outdoor intrusion detection system is a technology for detecting whether there is an object that intrudes from the outside to the inside, although the object is not allowed to enter a specific space according to time or authorization.

This outdoor intrusion detection system is installed in the perimeter of a security zone.

Existing outdoor intrusion detection systems have used vibration sensors, tension sensors, infrared (IR) sensors, and microwave sensors.

A multi-detector having microwave detector and passive infrared detector disclosed in Korean Utility Model Registration Publication No. 20-0344717 has a limitation in use since the sensing region is narrow as a receiver and a transmitter are installed in the same device, in which an intruder may escape easily.

In addition, the multi-detector having microwave detector and passive infrared detector disclosed in the prior art has a limitation in use for the outdoor, as the device is intended for indoor use.

In addition, the infrared disclosed in the related document is a type that monitors the motions of an intruder through temperature sensing, and it has a disadvantage in that a false alarm may be triggered according to variations in the indoor temperature.

In a case of the existing microwave sensing type, there is a disadvantage in that electromagnetic interference due to small animals, swaying tree branches or trembling entrance doors, and movements of transport vehicles in the vicinity of detectors may also trigger an alarm, and may result in waste of dispatching manpower and time in response to a false alarm.

In a case of existing infrared sensing type (the radiation intensity sensing type), it has a disadvantage in that falling leaves, snow, or rain may also trigger an alarm due to a narrow beam width of the infrared light and may result in waste of dispatching manpower and time in response to a false alarm.

### SUMMARY OF THE INVENTION

Aspects of the present invention are to address at least the above-mentioned problems and/or disadvantages and provide at least the advantages described below.

Accordingly, an aspect of the present invention is to provide an outdoor intrusion detection system capable of avoiding a false alarm due to weather conditions, small objects and the like, so as to improve the reliability of the intrusion detection.

Additional aspects will be set forth in part in the description which follows and, in part, will be apparent from the description, or may be learned by practice of the presented embodiments. Accordingly, an aspect of the present invention, an outdoor intrusion detection system is provided for detecting throughout a wider coverage area.

In accordance with an aspect of the present invention, an outdoor intrusion detection system is provided. The outdoor intrusion detection system includes a transmitter transmitting microwaves and infrared light, and a receiver receiving transmitted microwaves and infrared light transmitted from the transmitter.

The transmitter includes a microwave transmitting unit generating the microwaves and transmitting to the receiver, an infrared transmitting unit transmitting infrared light to the receiver by diffusing the generated infrared light.

The receiver determines that there is an intrusion when receiving transmitted microwaves and infrared light from the receiver, a waveform of the received microwaves or the frequency deviating from a predetermined threshold value, and the received intensity of infrared light is equal to or less than the predetermined threshold value.

The microwave transmitting unit may include an antenna emitting microwaves, a reflector receiving the emitted microwaves from the antenna and transmitting towards the receiver disposed on a rear surface of the antenna.

The infrared transmitting unit may include an infrared source generating the infrared light, and a light-diffusing lens expanding the beam width generated from the infrared source disposed on a front surface of the infrared source.

A lens insertion hole is formed on one surface of the reflector in which the light-diffusing lens is inserted, the infrared source is disposed on a rear surface of the reflector, and the light-diffusing lens may be disposed on a front surface of the infrared light.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a view for describing a sensing width and a sensing length of an outdoor intrusion detection system according to an embodiment of the present invention;

FIG. 2 is a block diagram of the outdoor intrusion detection system according to an embodiment of the present invention;

FIG. 3 is an exploded view of a transmitter according to an embodiment of the present invention; and

FIG. 4 is a view of the interior of the transmitter according to an embodiment of the present invention.

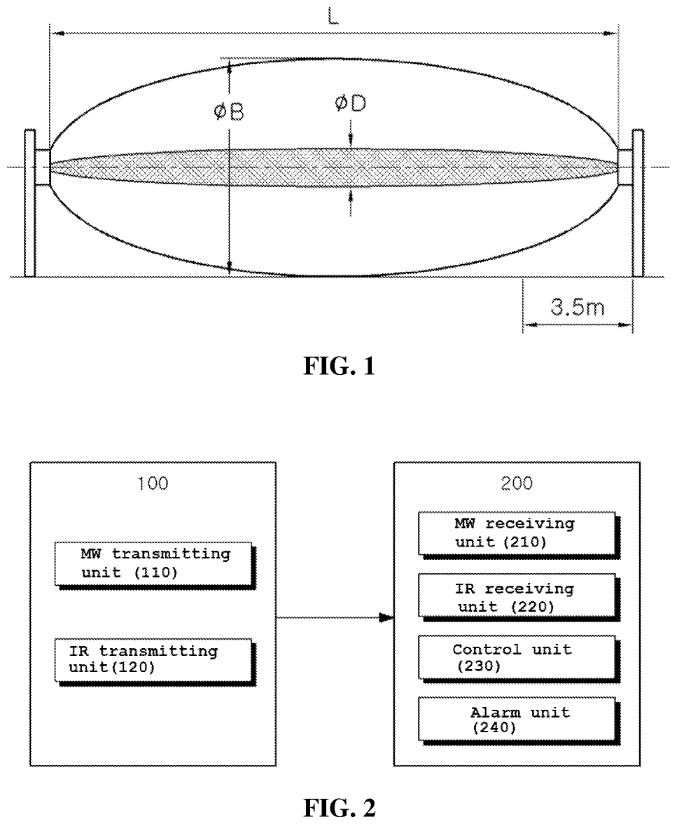

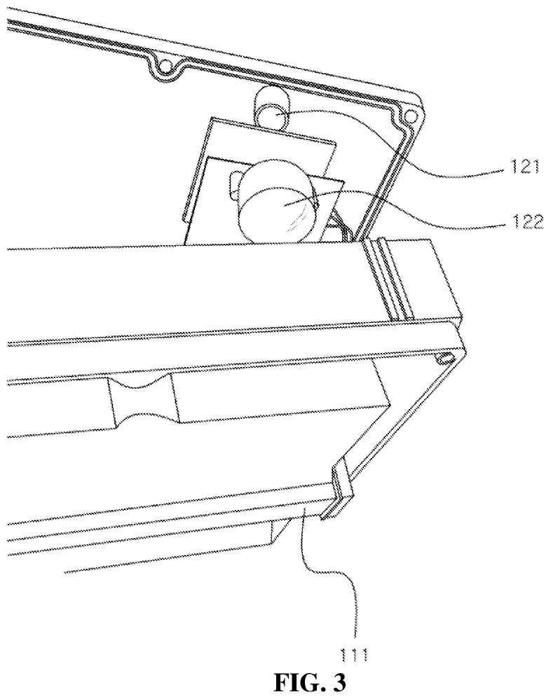

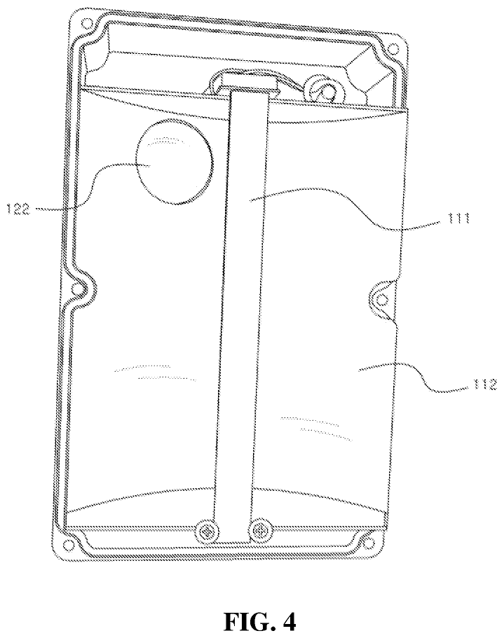

### DESCRIPTION OF SYMBOLS

100: Transmitter
110: Microwave transmitting unit
111: Antenna
121: Reflector
120: Infrared transmitting unit
121: Infrared source
122: Light-diffusing lens
200: Receiver
210: Microwave receiving unit
220: Infrared receiving unit
230: Control unit
240: Alarm unit

### DETAILED DESCRIPTION OF THE PREFERRED EMBODIMENT

The inventive concept will now be described more fully hereinafter with reference to the accompanying drawings, in which exemplary embodiments of the inventive concept are shown. It should be noted that the inventive concept is not limited to the following exemplary embodiments, and may be implemented in various forms. However, it should be understood that the following exemplifying description of the invention is not meant to restrict the invention to specific forms of the present invention but rather the present invention is meant to cover all modifications, similarities and alternatives which are included in the spirit and scope of the present invention.

Expressions such as “first” or “second” used in the present invention may be used to identify various elements regardless of order and/or importance, and may be used merely to differentiate one element from another but the relevant elements should not be limited thereto. These terms are only used to distinguish one element from another. For example, a first element could be termed a second element, and, similarly, a second element could be termed a first element, without departing from the scope of the present invention.

It will be understood that when an element is referred to as being “connected with” another element, it can be directly connected with the other element or intervening elements may also be present. In contrast, when an element is referred to as being “directly connected with” another element, there are no intervening elements present. Meanwhile, other expressions describing relationships between components such as “between”, “immediately between” or “adjacent to” and “directly adjacent to” may be construed similarly.

The terminology used herein is for the purpose of describing particular exemplary embodiments only and is not intended to be limiting of the inventive concept. Unless otherwise defined specifically, a singular expression may encompass a plural expression. It is to be understood that the terms such as a “comprise” or “consist of” are used herein to designate a presence of characteristic, number, operation, element, part, or a combination thereof, and not to preclude a presence or possibility of adding one or more of other characteristics, numbers steps operations elements, parts or a combination thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein. Hereinafter, preferred embodiments of the present invention will be described in greater detail below with reference to the attached drawings.

The outdoor intrusion detection system according to an embodiment of the present invention includes a receiver 200 and a transmitter 100.

### Transmitter 100

A transmitter 100 according to an embodiment of the present invention includes a microwave transmitting unit 110, and an infrared transmitting unit 120.

1. Microwave Transmitting Unit 110

A microwave transmitting unit 110 according to an embodiment of the present invention includes an antenna 111 generating microwaves, and a reflector 112 reflecting, by receiving emitted microwaves from the antenna 111, to the direction of transmitter 100.

The antenna 111 in a metallic bar shape may emit microwaves. The frequency of microwaves emitted from the antenna 111 may range from 20 GHz to 25 GHz band. Preferably, the frequency of microwaves may be 24.125 GHz.

The reflector 112 is disposed on a rear surface of the antenna 111 so as to receive and reflect the microwaves emitted from the antenna and transmit in the direction of a receiver 200.

A lens insertion hole, which a light-diffusing lens 122 may be inserted into, and will be described later, may be formed on the reflector 112.

The microwaves transmitted from a microwave transmitting unit 110 according to an embodiment of the present invention to a receiver 200 may form a sensing region in a long ellipsoid of a rotation.

2. Infrared Transmitting Unit 120

An infrared transmitting unit 120 according to an embodiment of the present invention includes an infrared source 121 generating the infrared light, and a light-diffusing lens 122 radiating the generated infrared light from the infrared source 121.

The infrared source 121 is disposed on a rear surface of the reflector 112, and the light-diffusing lens 122 may be inserted into a lens insertion hole of the reflector 112.

The light-diffusing lens 122 is disposed on a front surface of the infrared source 121 so as to diffuse an infrared beam discharged from the infrared transmitting unit, and diffuse towards the transmitter 100.

The infrared used for the existing infrared intrusion detection method provided a narrow beam width in which there is a disadvantage of the intrusion detection may be activated due to snow, rain, falling leaves, and small birds, however, the present invention may use the light-diffusing lens 122 so as to expand the beam width of the infrared light and avoid triggering a false alarm in a situation as described above.

### Receiver 200

A receiver 200 according to an embodiment of the present invention may include a microwave receiving unit 210, an infrared receiving unit 220, a control unit 230, and an alarm unit 240.

1. Microwave Receiving Unit 210

A microwave receiving unit 210 receives microwaves transmitted from the microwave transmitting unit 110, and a waveform of the received microwaves is transferred to a control unit 230.

In a case of an intruder passing through the sensing region, the waveform of the microwaves received from the microwave receiving unit 210 is different from the waveform of the microwaves transmitted from the microwave transmitting unit 110. That is, when the intruder passing through the sensing region, the amplitude and/or frequency of microwaves vary significantly.

The microwave receiving unit 210 transfers the waveform of received microwaves to the control unit 230.

2. Infrared Receiving Unit 220

The infrared receiving unit 220 receives infrared light transmitted from the light-diffusing lens 122, and transfers the intensity of infrared light to the control unit 230.

When an intruder passes through the sensing region, the intensity of infrared light received from the infrared receiving unit 220 is decreased through the light-diffusing lens 122 compared to the transmitted intensity of the infrared light. The infrared receiving unit 220 transmits the intensity of an infrared light signal received from the infrared receiving unit 220.

3. Control Unit 230

The control unit 230 receives the waveform of the microwaves received from the microwave receiving unit 210 and receives the intensity of infrared light from the infrared receiving unit 220.

The control unit 230 may store the amplitude and frequency of microwave emitted from the antenna 111 in advance. In addition, the control unit 230 may store the intensity of infrared light 121 generated from the infrared source of the infrared transmitting unit 120.

The control unit 230 may determine that there is an intrusion in the sensing region when the amplitude and/or the frequency of the microwave transmitted from the microwave receiving unit 210 deviates from a predetermined threshold, and the received intensity of infrared light is equal to or less than a predetermined threshold value.

That is, the control unit 230 determines that there is an intrusion when both the amplitude and/or frequency of microwaves and the intensity of infrared light are equal to or less than a predetermined value. That is, the control unit 230 determines that there is an intrusion when the waveform of received microwaves deviates from the predetermined threshold, and the intensity of infrared light received is less than the threshold value.

In contrast, the control unit 230 does not determine that there is an intrusion when both the amplitude and/or frequency of microwaves do not deviate from the predetermined value and the intensity of infrared light is equal to or less than a predetermined value. The control unit 230 does not determine that there is an intrusion when the received amplitude and/or frequency of microwaves deviate, but also when the received intensity of infrared light does not deviate from the predetermined value.

When the control unit 230 determines that there is an intrusion in the sensing region as described above, an alarm trigger signal that controls to generate an alarm in an alarm unit 240, which will be described later, generates and transmits to the alarm unit 240.

The control unit 230 may determine that there is the intrusion in applying an infrared sensing method, in a case where the received intensity of the infrared light 121 is equal to or less than 0.5, when the intensity of infrared light generated from the infrared source of the infrared transmission unit.

The beam width of the infrared light may range from 0.03 meters to 0.2 meters.

A sensing length (L), according to an embodiment of the present invention may range from 10 meters to 100 meters. In addition, the sensing width of microwaves ranges from 0.5 meters to 0.2 meters, and the sensing width of infrared may range from 0.03 meters to 0.2 meters.

The sensing length (L) herein represents the length between a receiver 200 and a transmitter 100. Further, the sensing width represents the maximum length of microwaves or the infrared beam width.

In a case where the intrusion detection method using microwaves transmits the microwaves penetrating through the liquid, there is a disadvantage in that a false alarm may trigger as the liquid is determined as an intruder. Specifically, when the intrusion detection method using microwaves is installed in the outdoor area, there is a disadvantage in that a false alarm may trigger when a thin film of water is created in the transmitter or determine raindrops as an intruder. In addition, there is a disadvantage in that the intrusion detection method using microwaves is less reliable as there may be electromagnetic interference due to swaying tree branches and movements of transport vehicles in the vicinity of detectors.

Accordingly, there is a drawback in detecting an intruder accurately by only using the microwave sensing method.

To improve the intrusion detection method using microwaves, the intrusion detection methods using both microwaves and a reduction in the intensity of infrared light are used together.

The beam width of existing infrared light is merely 0.1 millimeters wide having a narrow sensing width, in which there is a disadvantage in that a false alarm may trigger by reducing the intensity of infrared light received in a receiver due to snow, rain, hail, or small birds.

To improve such an existing method for sensing a reduction in the intensity of infrared light of the present invention, a light-diffusing lens 122 is disposed on a front surface of an infrared source 121, where the infrared light is generated. The infrared light generated from the infrared source 121 is diffused by the light-diffusing lens 122, thereby the beam width of infrared light is increased and transmitted towards the receiver 200.

According to the present invention, a reduction of the intensity of infrared light due to the snow, rain, and small birds is lowered by using the existing infrared sensing method. Consequently, when snow, rain, or small birds pass through the infrared light, the present invention does not sense that there is an intruder and is advantageous in terms of reduction in manpower and time due to a false alarm triggered.

4. Alarm Unit 240

An alarm unit 240 according to the present invention notifies intrusion detection to the outside when an alarm triggering signal is received from a control unit 230. Preferably, the alarm unit 240 triggers an alarm visually or acoustically to the outside or transmits the intrusion detection signal to a terminal of an administrator.

The alarm unit 240 according to an embodiment of the present invention is provided with a plurality of LEDs, and a light indicating an intrusion warning may be emitted from the LEDs.

In accordance with an aspect of the present invention, an outdoor intrusion detection system is advantageous in terms of providing the outdoor intrusion detection system in which a false alarm triggered by detecting an intruder due to a small object is avoided using microwaves and diffused infrared light.

What is claimed is:

1. An outdoor intrusion detection system comprising:
a transmitter configured to transmit microwaves and infrared light; and
a receiver configured to receive transmitted microwaves and infrared light transmitted from the transmitter;
wherein
the transmitter comprises:
a microwave transmission unit generating the microwaves and transmitting to the receiver; and
an infrared light transmission unit transmitting infrared light to the receiver by diffusing the generated infrared light, and
the receiver configured to:
receive microwaves and infrared light transmitted from the transmitter;
determine as that there is an intrusion when an amplitude or a frequency of a waveform of the microwaves received deviates from a predetermined threshold value; and
the intensity of the infrared light received is equal to or less than a predetermined threshold value.

2. The outdoor intrusion detection system according to claim 1, wherein the microwave transmitting unit comprises:
an antenna emitting microwaves,
a reflector receiving microwaves emitted from the antenna and transmitting to the receiver disposed on a rear surface of the antenna, and
the infrared transmitting unit comprises:
an infrared source generating the infrared light; and
a light-diffusing lens diffusing a beam width of infrared light generated from the infrared source by disposing on a front surface of the infrared source.

3. The outdoor intrusion detection system according to claim 2, wherein a lens insertion hole configured to insert the light-diffusing lens on one surface of the reflector, wherein
the infrared source is disposed on a rear surface of the reflector; and
the light-diffusing lens is disposed on a front surface of the infrared light.
